(19) United States
(12) Patent Application Publication
(10) Pub. No.: US 2015/0030012 A1
(43) Pub. Date: Jan. 29, 2015

(54) COMMUNICATION DEVICE

(71) Applicant: FUNAI ELECTRIC CO., LTD., Osaka (JP)

(72) Inventor: Shusuke NARITA, Osaka (JP)

(21) Appl. No.: 14/309,116

(22) Filed: Jun. 19, 2014

(30) Foreign Application Priority Data
Jul. 24, 2013 (JP) 2013-154026

(51) Int. Cl. H04W 76/02; H04W 84/12

(52) U.S. Cl. CPC H04W 76/023; H04W 84/12
USPC 370/338

(57) ABSTRACT

A display control device for communicating with an information terminal, the display control device including: a communication unit; a communication control unit which causes the communication unit to perform first communication in a local area network including the display control device and the information terminal, the first communication being communication between the display control device and the information terminal via a relay device; and a connection information obtainment unit which obtains, from the information terminal through the first communication, connection information necessary for establishment of second communication that is direct communication between the display control device and the information terminal, in which when the connection information obtainment unit obtains the connection information, the communication control unit causes the communication unit to break off the first communication and start the second communication using the obtained connection information.

### CROSS REFERENCE TO RELATED APPLICATION

The present application is based on and claims priority of Japanese Patent Application No. 2013-154026 filed on Jul. 24, 2013. The entire disclosure of the above-identified application, including the specification, drawings and claims is incorporated herein by reference in its entirety.

### FIELD

The present invention relates to a communication device.

### BACKGROUND

There is a technique in which an information terminal transfers an image displayed on the display screen to a display device, to display the image in the display device. Micracast is a specific example of such technique. In Micracast, a smartphone having a small display screen transfers an image displayed on the display screen to a television, to display the image in the television.

In a wireless network (wireless local area network (LAN)) in home, communication devices connect to an access point. That is, the communication devices connected to the wireless LAN in home connect to the access point using, for example, the ID of a network (a network ID) provided by the access point. These communication devices connected to the wireless LAN communicate via the access point.

Meanwhile, in Miracast, an information terminal and a display device communicate directly without connecting to the access point.

There has been a technique in which a communication device having various kinds of wireless communication units obtains, through direct communication with another communication device located near the communication device using one of the wireless communication units, the setting information of a wireless communication of the another communication unit (e.g., Patent Literature below).

### CITATION LIST

### Patent Literature

[PTL] Japanese Patent No. 4710477

### SUMMARY

### Technical Problem

For example, the following problems arise. It is difficult for a user to intuitively recognize information necessary for communication between an information terminal and a display device. As another problem, permission from the user is required before establishing the communication.

In view of the above problems, the present invention provides, for example, a communication device which can be connected to an information terminal in an easier way for users.

### Solution to Problem

To achieve the above object, a communication device according to an aspect of the present invention is a communication device for communicating with an information terminal. The communication device includes: a communication unit; a communication control unit which causes the communication unit to perform first communication in a local area network including the communication device and the information terminal, the first communication being communication between the communication device and the information terminal via a relay device; and a connection information obtainment unit which obtains, from the information terminal through the first communication, connection information necessary for establishment of second communication that is direct communication between the communication device and the information terminal, in which when the connection information obtainment unit obtains the connection information, the communication control unit causes the communication unit to break off the first communication and start the second communication using the obtained connection information.

According to this, the communication device can obtain the information necessary for the direct communication (the second communication) without the relay device, through the communication (the first communication) with the information terminal via the relay device. After obtaining the information, the communication device can establish the second communication, and perform processing using the second communication. That is, the communication device can establish the second communication with the information terminal in the local area network even if the user does not operate to input the necessary information for the second communication to the communication device. Thus, the communication device can be connected to the information terminal in an easier way for the user.

For example, the communication device may further include a memory unit capable of storing the connection information, in which the connection information obtainment unit may (i) receive, from the information terminal as the connection information, first identification information identifying the information terminal in the local area network, (ii) store the received first identification information in the memory unit, and (iii) send, to the communication device, second identification information identifying the communication device in the local area network, when a request for the establishment of the second communication is received from the information terminal, the communication control unit may determine whether or not to permit the establishment, based on the first identification information stored in the memory unit, and if the establishment is determined to be permitted, the communication control unit may cause the communication unit to start the second communication.

This allows the communication device to determine whether to permit or deny the establishment, using the information necessary for the second communication received from the information terminal through the first communication and the information included in the subsequent request for the establishment of the second communication from the information terminal. Thus, the communication device can establish the second communication with the information terminal with which the communication device performed the first communication.

Moreover, when the request for the establishment of the second communication is received from the information terminal and a sender of the request for the establishment matches a device identified by the first identification information stored in the memory unit, the communication control unit may determine to permit the establishment.

This allows the communication device to establish the second communication if the information necessary for the establishment of the second communication received from the information terminal through the first communication matches the information included in the subsequent request for the establishment of the second communication from the information terminal. This can ensure that the communication device establishes the second communication with the information terminal with which the communication device performed the first communication.

Moreover, the communication device may further include an initial setting unit which makes an initial setting of the communication device by performing a setting to enable the communication device to connect to the local area network, and causing the connection information obtainment unit to obtain the connection information.

This allows the communication device to obtain the information necessary for the second communication as one of the initial settings of the communication device. For instance, the initial settings of the communication device are performed by the user who purchased the communication device, to connect the communication device to the local area network in the home of the user.

Moreover, when the first identification information is received, the connection information obtainment unit may present, to a user, information for a query about whether or not to establish the second communication with a device identified by the received first identification information, and control the establishment of the second communication, depending on a response from the user to the query.

This allows the communication device to determine whether or not to establish the second communication, depending on the instruction indicated by the response from the user.

Moreover, if a response is not obtained from the user after elapse of a predetermined time since presenting an image for the query to the user, the connection information obtainment unit may control the establishment of the second communication by determining whether or not to establish the second communication.

This allows the communication device to determine (whether or not) to establish the second communication, even without a response from the user.

Moreover, when the connection information obtainment unit has received the first identification information and the device identified by the received first identification information has previously communicated with the communication device, the connection information obtainment unit may establish the second communication with the device identified by the received first identification information.

This allows the communication device to establish the second communication, without performing the processing of determining whether or not to establish the second communication, for the establishment request from the information terminal with which the communication device has previously communicated.

Moreover, the information terminal may create image data, and the second communication may include communication for sending the image data created by the information terminal to the communication device. The communication device may further include: a processing unit which receives the image data through the second communication, to create an image from the received image data; and a display control unit which controls display of the image created by the processing unit on a display screen.

This allows the communication device to cause the display device to display image data created by the information terminal.

It should be noted that the present invention can be achieved not only as a communication device or information terminal including such characteristic processing unit, but as a method whose steps represent the processing performed by the characteristic processing unit of the communication device or information terminal. Moreover, the present invention can be achieved as a program for causing a computer to perform the characteristic steps included in the program or method for allowing the computer to function as the characteristic processing unit of the communication device or information terminal. Such program can be, of course, distributed via a computer-readable non-transitory recording medium such as a compact disc-read only memory (CD-ROM) or a communication network such as the Internet.

### Advantageous Effects

According to the present invention, a communication device can be connected to an information terminal in a way more easily understood for users.

### BRIEF DESCRIPTION OF DRAWINGS

FIG. 1 is a block diagram of a communication system according to Embodiment 1.

FIG. 2A illustrates a hardware configuration of a display control device according to Embodiment 1.

FIG. 2B is a functional block diagram of an information terminal and the display control device according to Embodiment 1.

FIG. 3 is a flowchart of processing performed by the communication system according to Embodiment 1.

FIG. 4A is a sequence diagram of the processing performed by the communication system according to Embodiment 1.

FIG. 4B is a figure for explaining information used for the processing performed by the communication system according to Embodiment 1.

FIG. 5 is a sequence diagram of processing performed by a communication system according to Embodiment 2.

FIG. 6 is an example of a display image controlled by a display control device according to Embodiment 2.

FIG. 7 is a sequence diagram of processing performed by a communication system according to Embodiment 3.

FIG. 8 is a figure for explaining switching between the functions of a display control device according to Embodiment 4.

FIG. 9 is a figure for explaining switching between the functions of an information terminal according to Embodiment 4.

### DESCRIPTION OF EMBODIMENTS

The following describes the embodiments of the present invention in detail with reference to the drawings. It should be noted that each of the following embodiments shows a preferred specific example of the present invention. Numerical values, shapes, materials, structural elements, the arrangement and connection of the structural elements, steps, the order of the steps, and others indicated in the following embodiments are mere examples, and are not intended to limit the present invention. The present invention is defined by Claims. Therefore, among the structural elements in the following embodiments, the structural elements not recited in the independent claims are not necessarily used to achieve the problems of the present invention, but are used to form a more preferable embodiment.

### Embodiment 1

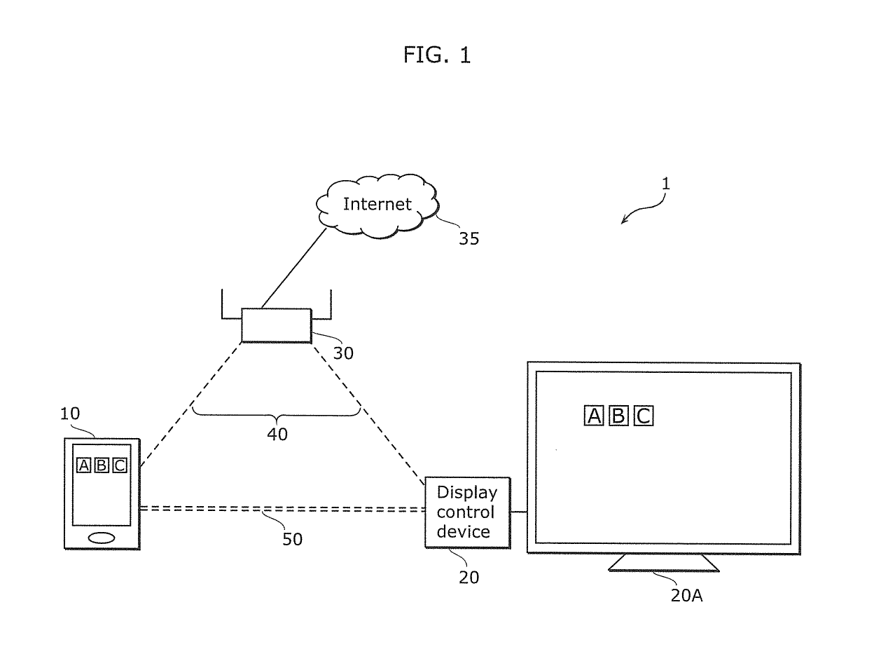

FIG. 1 is a block diagram of a communication system according to the present embodiment.

As FIG. 1 illustrates, a communication system 1 according to the present embodiment includes an information terminal 10, a display control device 20, a display device 20A, and a relay device 30.

The information terminal 10 is a device for receiving an input from a user, and presenting information to the user by audio or image display. Moreover, the information terminal 10 has a communication interface enabling communication 40 with other device via a relay device or direct communication 50 with other device. For instance, the information terminal 10 can access a server on the Internet 35 using the communication 40, and display a website on the screen of the information terminal 10 in accordance with information obtained from the web server. Moreover, the information terminal 10 can send the image data of the image displayed on the screen of the information terminal 10 to the display control device 20, using the communication 50. Then, the information terminal 10 can cause the display control device 20 to control display of the image.

The display control device 20 controls display of an image. The display control device 20 is connected to the display device 20A, and controls whether or not to display an image in the display device 20A. Furthermore, the display control device 20 controls an image to be displayed in the display device 20A. That is, the display control device 20 sends an image to the display device 20A, and causes the display device 20A to display the image. Moreover, the display control device 20 has a communication interface enabling the communication 40 with other device via a relay device or the direct communication 50 with other device. For instance, the display control device 20 can access a web server on the Internet 35, using the communication 40, create an image in accordance with information obtained from the web server, and cause the display device 20A to display the created image. Moreover, the display control device 20 can receive image data from the information terminal 10, and cause the display device 20A to display the received image. It should be noted that the display control device 20 is an example of the communication device. Specifically, the display control device 20 corresponds to a set-top box (STB) or tuner. Moreover, the display control device 20 may include the display device 20A.

The display device 20A displays an image. In the present embodiment, the display device 20A is connected to the display control device 20, and displays an image received from the display control device 20. A television is a specific example of the display device 20A.

The relay device 30 relays communication between devices connected to the relay device 30. In the present embodiment, the relay device 30 is connected to the information terminal 10 and the display control device 20, and provides the communication 40 for the information terminal 10 and the display control device 20. That is, the relay device 30 receives communication data sent by the information terminal 10, and sends the data to the display control device 20. The relay device 30 also receives communication data sent by the display control device 20, and sends the data to the information terminal 10. The relay device 30 is also connected to the server on the Internet 35, which allows the relay device 30 to relay communication between the server and the information terminal 10 or the display control device 20.

It should be noted that a network including the devices connected to the relay device 30 is an example of a local area network (hereinafter, also referred to as LAN).

It should be noted that the information terminal 10 and the display control device 20 respectively correspond to a source device and a sync device in Miracast.

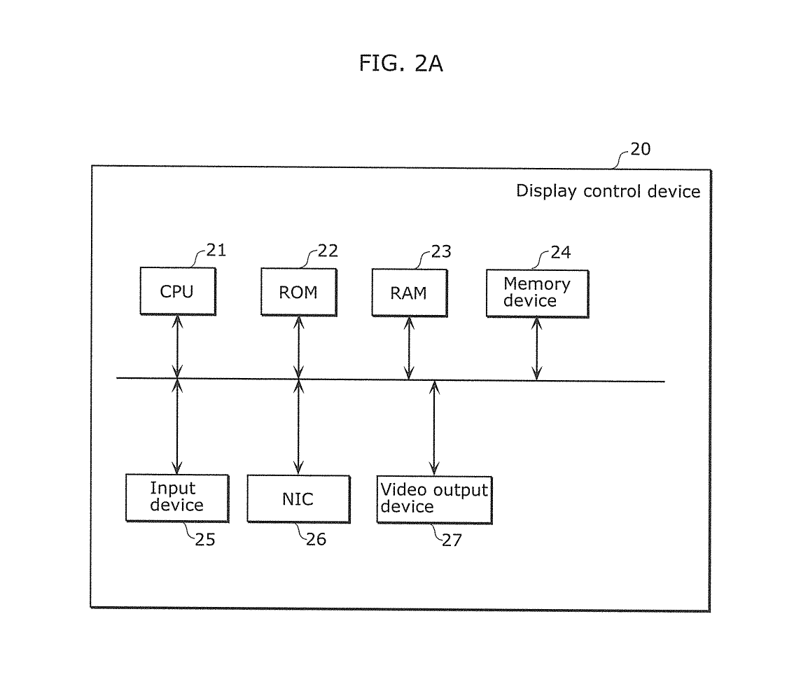

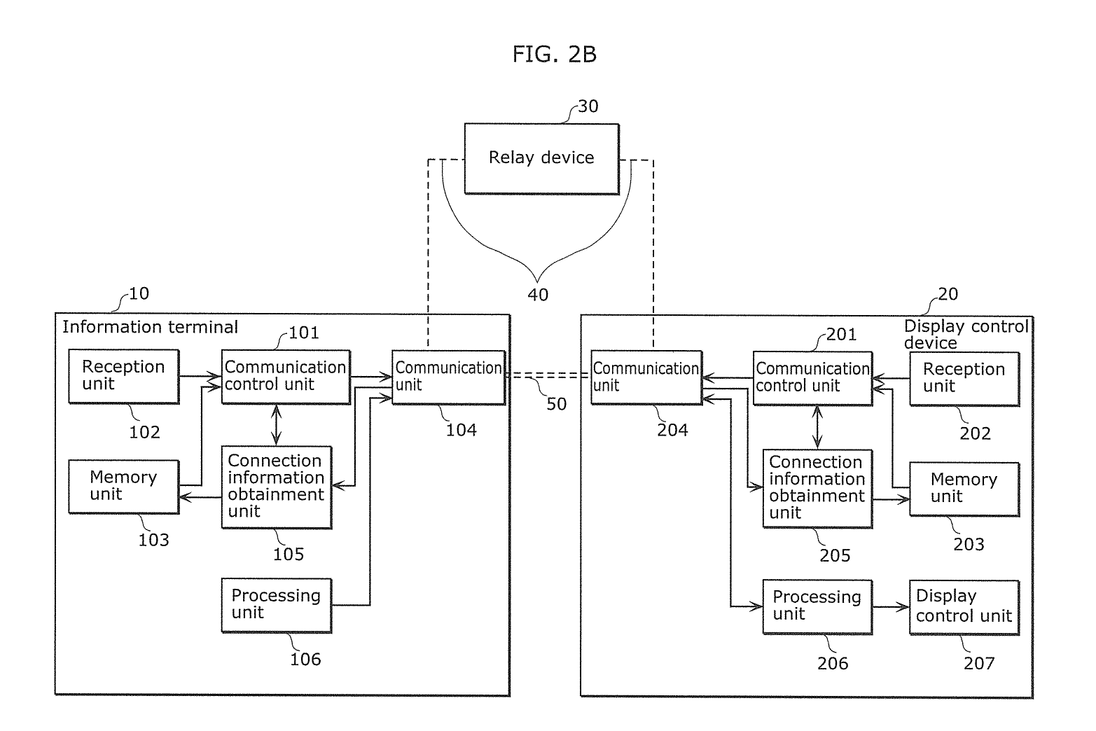

FIG. 2A illustrates a hardware configuration of the display control device according to the present embodiment.

As FIG. 2A illustrates, the display control device 20 includes a central processing unit (CPU) 21, a read only memory (ROM) 22, a random access memory (RAM) 23, a memory device 24, an input device 25, a network interface card (NIC) 26, and a video output device 27.

The CPU 21 is a processor for executing a control program stored in the ROM 22.

The ROM 22 is a read only memory area for retaining the control program or others.

The RAM 23 is a volatile memory area which is used as a work area used when the CPU 21 executes the control program.

The memory device 24 is a volatile memory area for retaining, for example, the control program or image data.

The input device 25 receives an input from the user. Specifically, the input device 25 is, for example, a touch panel for detecting a touch to a screen as an input, a remote control for receiving a signal as an input using, for example, infrared ray, or a button for detecting the depression of the button as an input. Moreover, the input device 25 may include a device for receiving an input from the user in various other ways not described above.

The NIC 26 is a communication interface for sending communication data to the network or receiving communication data from the network. It should be noted that the network to which the NIC 26 connects may be a wired LAN compliant with, for example, IEEE802.3 standard, or may be a wireless LAN compliant with, for example, IEEE802.11a, b, and g standards.

The video output device 27 generates and outputs a video signal.

It should be noted that the information terminal 10 according to the present embodiment includes a CPU, a ROM, a RAM, a memory device, an input device, and an NIC. Each structural element has the same function as the structural element of the same name in the display control device 20.

FIG. 2B is a functional block diagram of the information terminal and the display control device according to the present embodiment.

As FIG. 2B illustrates, the information terminal 10 according to the present embodiment includes a communication control unit 101, a reception unit 102, a memory unit 103, a communication unit 104, a connection information obtainment unit 105, and a processing unit 106.

The communication control unit 101 controls the communication of the communication unit 104. Specifically, the communication control unit 101 causes the communication unit 104 to perform the communication 40 (the first communication) between the information terminal 10 and the display control device 20 via the relay device 30 in a local area network. Moreover, if the connection information obtainment unit 105 obtains connection information, the communication control unit 101 causes the communication unit 104 to break off the communication 40 and start the direct communication 50 (the second communication) with the display control device 20 using the obtained connection information. It should be noted that the communication control unit 101 is achieved by the CPU, ROM, RAM, or others.

The reception unit 102 receives an input from the user. Specifically, the reception unit 102 receives from the user an input indicating that the communication 50 is to be performed between the information terminal 10 and the display control device 20. It should be noted that the reception unit 102 is achieved by an input device or others.

The memory unit 103 preserves information necessary for the communication 50 and obtained by the connection information obtainment unit 105.

The communication unit 104 communicates with other device. Specifically, the communication unit 104 connects to the relay device 30, and performs the communication 40 (the first communication) with the display control device 20 via the relay device 30. Moreover, the communication unit 104 directly connects to the display control device 20, and performs the direct communication 50 (the second communication) with the display control device 20. The communication 40 corresponds to communication in the network in which devices connect to a wireless access point. At least an identifier which can uniquely identify a network (hereinafter, referred to as network ID) is necessary to perform the communication 40. If the communication 40 is performed through a wireless LAN compliant with IEEE802.11 standard, BSSID or ESSID can be used as a network ID. Moreover, the communication 50 corresponds to communication in the network in which devices directly connect to communicate. At least an identifier which can uniquely identify the network and an identifier (terminal ID) which can uniquely identify a communication partner device in the network are necessary to perform the communication 50. If the communication 50 is performed by Wi-Fi Direct, a Wi-Fi Direct connection name can be used as the network ID and the MAC address of the communication partner can be used as the terminal ID. It should be noted that the communication unit 104 is achieved by, for example, the NIC 26.

The connection information obtainment unit 105 obtains, through the communication 40, connection information necessary for the establishment of the direct communication 50 (the second communication) between the information terminal 10 and the display control device 20. Specifically, the connection information represents the Wi-Fi Direct connection name of the communication 50 and the MAC address of the display control device 20. A method for obtaining the connection information will be described later in detail. It should be noted that the connection information obtainment unit 105 is achieved by the CPU, ROM, RAM, or others.

The processing unit 106 performs predetermined processing, using the communication 50. The predetermined processing is, for example, the processing of sending image data. Here, the image data may be the image data of an image displayed on the screen of the information terminal 10 when the processing is performed, or may be other image data. Moreover, the image data may be data representing a motion picture or data representing a still picture. It should be noted that the processing unit 106 is achieved by the CPU, ROM, RAM, or others.

It should be noted that the initial settings of the information terminal 10 may include a setting for connecting the information terminal 10 to the local area network and obtainment of the connection information by the connection information obtainment unit 105. Here, the initial setting is, for example, an initial setup performed after the user purchases the information terminal 10. Moreover, the information terminal 10 may include an initial setting unit (not illustrated in the figure) for performing initial settings as described above.

Moreover, the display control device 20 according to the present embodiment includes a communication control unit 201, a reception unit 202, a memory unit 203, a communication unit 204, a connection information obtainment unit 205, a processing unit 206, and a display control unit 207.

The communication control unit 201 controls the communication of the communication unit 204. Specifically, the communication control unit 201 causes the communication unit 204 to perform the communication 40 (the first communication) between the display control device 20 and the information terminal 10 via the relay device 30 in the local area network. Moreover, if the connection information obtainment unit 205 obtains connection information, the communication control unit 201 causes the communication unit 204 to break off the communication 40 and start the direct communication 50 using the obtained connection information. It should be noted that the communication control unit 201 is achieved by the CPU, ROM, RAM, or others.

The reception unit 202 receives an input from the user. Specifically, the reception unit 202 receives from the user an input indicating that the communication 50 is to be performed between the display control device 20 and the information terminal 10. It should be noted that the reception unit 202 is achieved by an input device or others.

The memory unit 203 preserves information necessary for the communication 50 and obtained by the connection information obtainment unit 205.

The communication unit 204 communicates with other device. Specifically, the communication unit 204 connects to the relay device 30, and performs the communication 40 (the first communication) with the information terminal 10 via the relay device 30. Moreover, the communication unit 204 directly connects to the information terminal 10, and performs the direct communication 50 (the second communication) with the information terminal 10. It should be noted that the communication unit 204 is achieved by the NIC 26 or others.

The connection information obtainment unit 205 obtains, through the communication 40, connection information necessary for the establishment of the direct communication 50 (the second communication) between the information terminal 20 and the display control device 10. The connection information is specifically the Wi-Fi Direct connection name of the communication 50 and the MAC address of the information terminal 10. It should be noted that the connection information obtainment unit 205 is achieved by the CPU, ROM, RAM, or others.

The processing unit 206 performs predetermined processing, using the communication 50. The predetermined processing is, for example, the processing of receiving image data created by the information terminal, through the communication 50 and causing the display device to display an image represented by the received image data. It should be noted that the processing unit 206 is achieved by the CPU, ROM, RAM, or others.

The display control unit 207 generates a video signal and outputs the signal to the display device. It should be noted that the display control unit 207 is achieved by the video output device 27 or others.

It should be noted that the initial settings of the display control device 20 may include a setting for connecting the display control device 20 to the local area network and obtainment of connection information by the connection information obtainment unit 205. Here, the initial setting is, for example, an initial setup performed after the user purchases the display control device 20. Moreover, the display control device 20 may include an initial setting unit (not illustrated in the figure) for performing initial settings as described above.

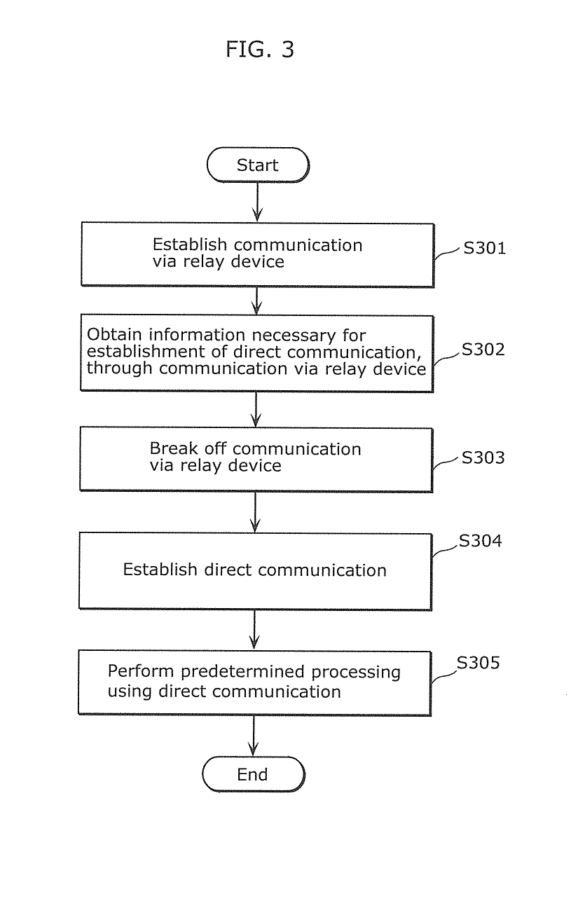

FIG. 3 is a flowchart illustrating processing performed by a communication system according to the present embodiment.

The information terminal 10 and the display control device 20 perform the communication 40 via the relay device 30 (Step S301). Each of the information terminal 10 and the display control device 20 connects to the relay device 30 using information for connecting to the relay device 30. The information is obtained by the user referring to the setting information of the relay device 30 or other information, and is set to each of the information terminal 10 and the display control device 20. If the information terminal 10 and the display control device 20 can communicate with the relay device 30, the information terminal 10 and the display control device 20 can communicate. This means that establishment of the communication 40 is completed.

Subsequently, the information terminal 10 and the display control device 20 obtain information necessary for the establishment of the communication 50, using the communication 40 (Step S302). Each of the information terminal 10 and the display control device 20 sends, as the information necessary for the establishment of the communication 50, its MAC address and Wi-Fi Direction connection name to the communication partner device. This allows each of the information terminal 10 and the display control device 20 to obtain and retain the MAC address and Wi-Fi Direct connection name of the communication partner device. It should be noted that the above processing may be performed by receiving an input from the user, or may be automatically performed irrespective of an input from the user.

The information terminal 10 and the display control device 20 break off the communication 40 (Step S303).

The information terminal 10 and the display control device 20 start the establishment of the communication 50 (Step S304). Each of the information terminal 10 and the display control device 20 sends, to the partner device, a request for the establishment of the communication 50 (direct communication). After receiving a connection response indicating that the partner device receives the connection request, each device can perform the communication 50 with the partner device.

The information terminal 10 and the display control device 20 perform predetermined processing, using the communication 50 (Step S305). In the predetermined processing, the information terminal 10, for example, creates image data and sends the created image data through the communication 50. Then, the display control device 20 receives the image data through the communication 50, and causes the display device to display an image represented by the received image data.

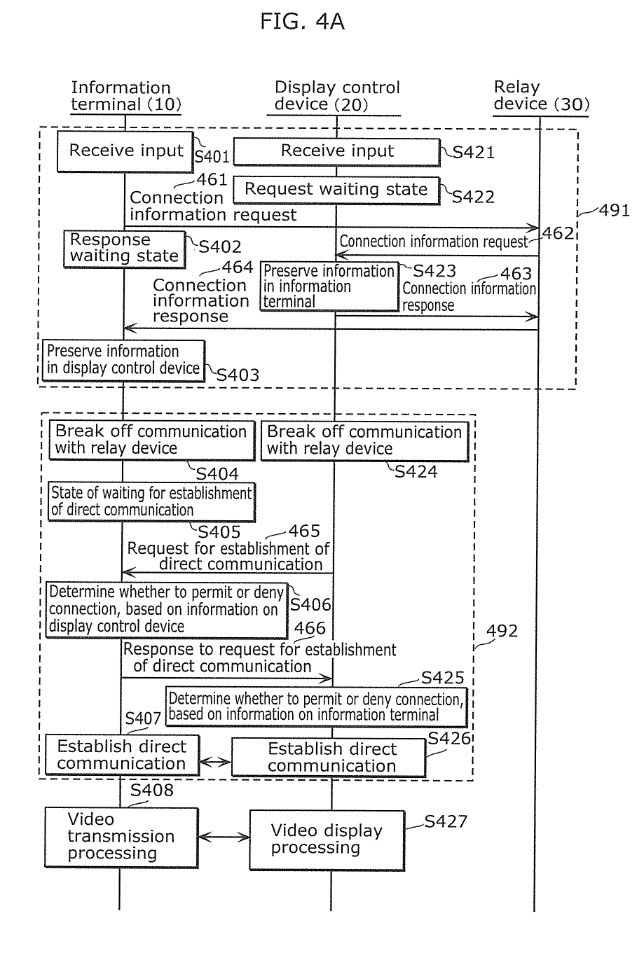

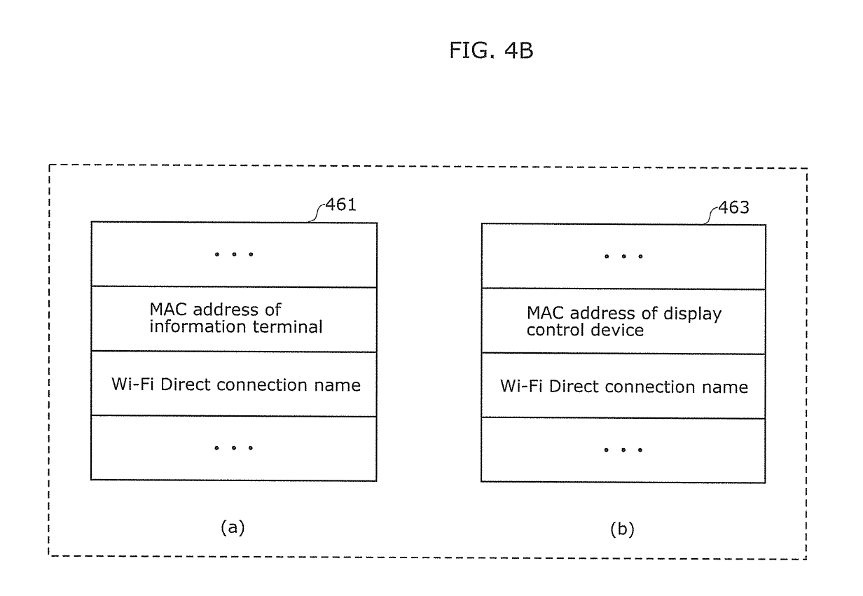

FIG. 4A is a sequence diagram illustrating the processing performed by the communication system according to the present embodiment. Moreover, FIG. 4B is a figure for explaining information used in the processing performed by the communication system according to the present embodiment. With reference to FIGS. 4A and 4B, the following further describes in detail the processing performed by the communication system according to the present embodiment.

It should be noted that FIG. 4A is a figure for explaining processing in the state where the communication 40 has been established between the information terminal 10 and the display control device 20 via the relay device 30. In the state where the communication 40 has been established, setting information for connecting to the relay device 30 is set to each of the information terminal 10 and the display control device 20, which are, in fact, connected to the relay device 30 using the setting information.

The information terminal 10 receives an input from the user (Step S401).

Moreover, the information terminal 20 receives an input from the user (Step S421). When the input from the user is received, the display control device 20 enters a waiting state (Step S422).

When the input from the user is received in Step S401, the information terminal 10 sends a connection information request 461 by broadcast within the LAN. The connection information request 461 includes at least the MAC address of the information terminal 10, which is a sender, and the Wi-Fi Direct connection name of the direct connection 50 to be subsequently performed ((a) in FIG. 4B). The connection information request 461 may further include the model name of the information terminal 10, the size of the display screen, or information on the user of the information terminal 10.

After sending the connection information request 461, the information terminal 10 enters a response waiting state (Step S402).

The relay device 30 receives the connection information request 461 sent by the information terminal 10, and transfers within the LAN as a connection information request 462.

The display control device 20 receives the connection information request 462. When the connection information request 462 is received, the display control device 20 preserves, in the memory unit, the information on the information terminal 10 included in the connection information request 462 (Step S423).

The display control device 20 sends, to the information terminal 10, a direct connection response 463 as a response to the connection information request 462. The connection information response 463 includes at least the MAC address of the display control device 20, which is a sender, and the Wi-Fi Direct connection name of the communication 50 to be subsequently performed ((b) in FIG. 4B). The connection information response 463 may further include the model name of the display control device 20, the size of the display screen, or information on the user of the display control device 20.

The relay device 30 receives the direct connection response 463, and sends, to the information terminal 10, the direct connection response 463 as a direct connection response 464.

The information terminal 10 receives the direct connection response 464. When the direct connection response 464 is received, the information terminal 10 preserves, in the memory unit, the information on the display control device 20 included in the direct connection response 464 (Step S403).

By processing 491 including the steps so far, the information terminal 10 and the display control device 20 obtain, using the communication 40, the connection information of the direct communication 50 to be subsequently performed.

The information terminal 10 breaks off the communication 40 with the relay device 30 (Step S404). After breaking off the communication 40, the information terminal 10 enters the waiting state of the establishment of the communication 50 (Step S404).

Moreover, the display control device 20 breaks off the communication 40 with the relay device 30 (Step S424). After breaking off the communication 40 with the relay device 30, the display control device 20 sends a connection request 465 of the communication 50 to the information terminal 10.

When the connection request 465 is received, the information terminal 10 determines whether to permit or deny the establishment of the communication 50, based on information included in the received connection request 465. Specifically, the information terminal 10 determines whether or not a MAC address and a Wi-Fi Direct connection name included in the connection request 465 are respectively identical to the MAC address and Wi-Fi Direct connection name of the display control device 20 received in Step 403 (Step S406).

If the MAC addresses and Wi-Fi Direct connection names are determined to be identical, the information terminal 10 permits the establishment of the communication 50 for the connection request 465, and sends a connection response 466 to the display control device 20 as a response to the connection request 465.

When the connection response 466 is received, the display control device 20 determines whether to permit or deny the establishment of the communication 50, based on information included in the received connection response 466. Specifically, the display control device 20 determines whether or not a MAC address and a Wi-Fi Direct connection name included in the connection response 466 are respectively identical to the MAC address and Wi-Fi Direct connection name of the information terminal 10 received in Step S423 (Step S425).

If the MAC addresses and Wi-Fi Direct connection names are determined to be identical, the display control device 20 permits the establishment of the communication 50 for the connection response 466.

By processing 492 including the steps so far, the communication 50 is established in each of the information terminal 10 and the display control device 20 (Steps S407 and S426).

Subsequently, each of the information terminal 10 and the display control device 20 performs processing using the communication 50 (Steps S408 and 427). A specific example of this processing is image transfer processing (also referred to as video mirroring). That is, the information terminal 10 creates image data, and performs the processing of sending the created image data through the communication 50. That is, the communication 50 includes communication for sending the image data created by the information terminal 10 to the display control device 20. The display control device 20 causes the display device to display the image data received through the communication 50. The image data created by the information terminal 10 is displayed in the display device by the image transfer processing.

Thus, the display control device according to the present embodiment can obtain the information necessary for the direct communication 50 (the second communication) without the relay device, through the communication (the first communication) with the information terminal via the relay device. After obtaining the information, the display control device can establish the communication 50, and perform the processing using the communication 50. That is, the display control device can establish the communication 50 with the information terminal in the local area network even if the user does not operate to input the information necessary for the communication 50 to the communication device. Thus, the display control device can be connected to the information terminal in an easier way for the user.

### Embodiment 2

In the present embodiment, when either the information terminal 10 or the display control device 20 receives an input from a user, how the device which received the input is connected to the other device. It should be noted that the configuration of a communication system and the hardware configurations of the information terminal 10 and the display control device 20 are same as those described in Embodiment 1.

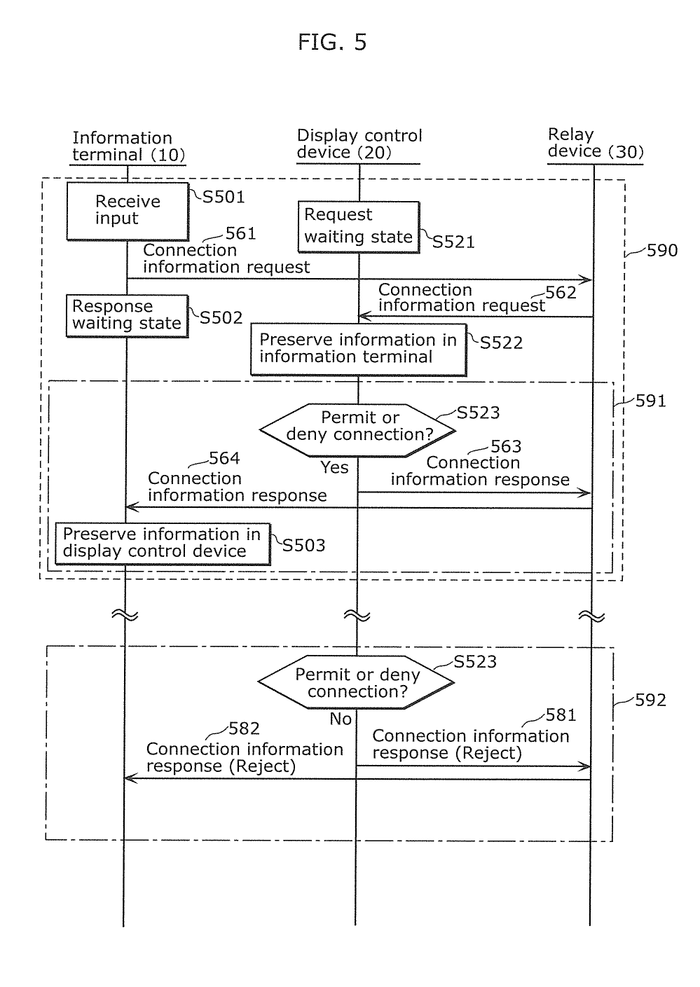

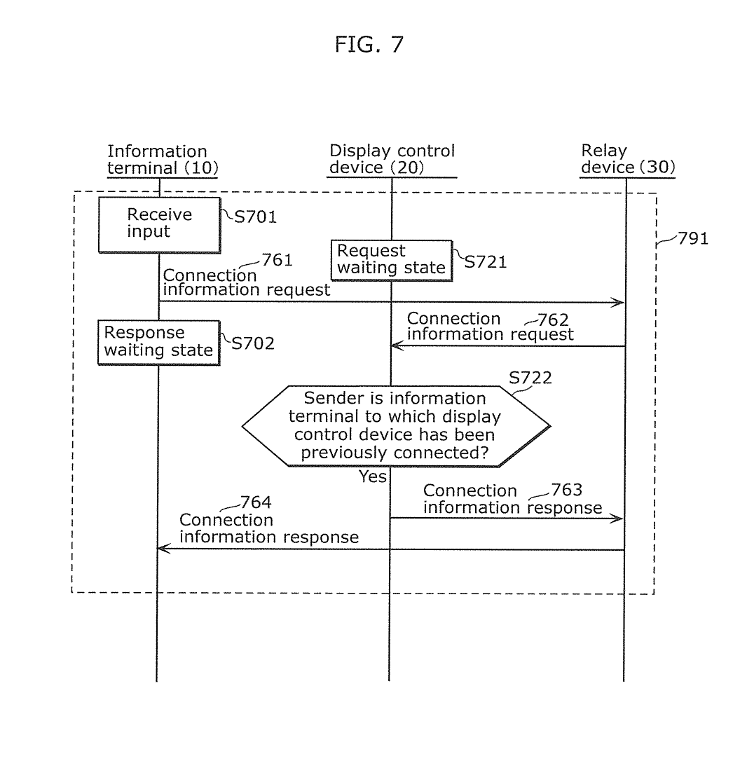

FIG. 5 is a sequence diagram illustrating processing performed by a communication system according to the present embodiment. The communication system performs processing 590 including the steps in FIG. 7 instead of the processing 491 in Embodiment 1.

The information terminal 10 receives an input from the user (Step S501). This step is same as Step S401 in Embodiment 1.

The display control device 20 enters a request waiting state (Step S521). In Embodiment 1, this step is performed after the display control device 20 receives an input from the user. In contrast, in the present embodiment, this step is performed without waiting an input from the user.

The information terminal 10 sends a connection information request 561 (and 562) to the display control device 20 via the relay device 30. The display control device 20 preserves information included in the received connection information request 562 (Step S522). This processing is same as the processing in Embodiment 1.

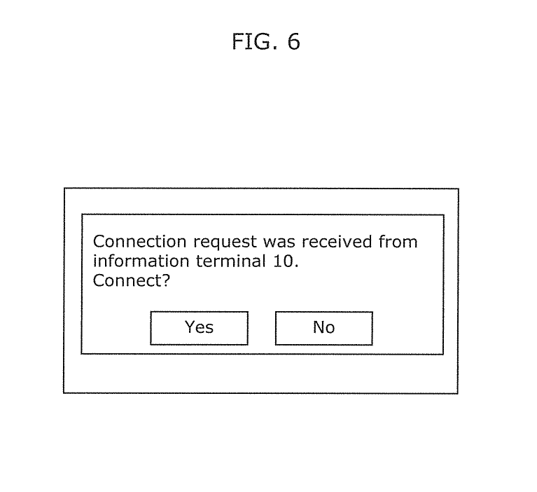

The display control device 20 determines whether or not to establish the direct communication 50 between the display control device 20 and the information terminal 10. This is determined based on a query to the user and a response from the user. For instance, the display control device 20 causes the display screen to display a message box as illustrated in FIG. 6 to present a query to the user. The display control device 20 receives, from the user, a response to a message in the message box. Specifically, when a response representing that the communication 50 is to be established is received (“Yes” in FIG. 6), the display control device 20 determines to establish the communication 50. Meanwhile, when a response representing that the communication 50 is not to be established is received (“No” in FIG. 6), the display control device 20 determines not to establish the communication 50.

It should be noted that when a predetermined time has elapsed since the start of the display of the message box on the display screen, the display control device 20 may determine whether or not to establish the communication 50 without receiving a response from the user.

When the display control device 20 determines “to establish the communication 50”, processing 591 is performed. That is, as with Embodiment 1, the display control device 20 sends a connection information response 563 (and 564) via the relay device 30. The information terminal 10 preserves information included in the received connection information response 564 (Step S503).

Meanwhile, when the display control device 20 determines “not to establish the communication 50”, processing 592 is performed. That is, the display control device 20 sends a connection information response 581 (and 582) representing denial for the establishment, to the information terminal 10 via the relay device 30. When the connection information response 582 is received, the information terminal 10 ends the processing.

Thus, the display control device according to the present embodiment can determine whether or not to establish the communication 50 according to an instruction represented by a response from the user.

Moreover, the display control device can determine (whether or not) to establish the communication 50 without a response from the user.

### Embodiment 3

In the present embodiment, when either the information terminal 10 or the display control device 20 receives an input from a user, how the device which received the input is connected to a previously connected device. It should be noted that the configuration of a communication system and the hardware configurations of the information terminal 10 and the display control device 20 are same as those described in Embodiment 1.

FIG. 7 is a sequence diagram illustrating processing performed by a communication system according to the present embodiment. The communication system performs processing 791 including the steps in FIG. 7 instead of the processing 491 in Embodiment 1.

The information terminal 10 receives an input from the user (Step S701). This step is same as Step S401 in Embodiment 1.

The display control device 20 enters a request waiting state (Step S721). This step is same as Step S521 in Embodiment 2.

The information terminal 10 sends a connection information request 761 (and 762) to the display control device 20 via the relay device 30. The display control device 20 determines, from information included in the received information request 762, whether or not the sender of the request is a device with which the display control device 20 has previously performed the direct communication 50.

When the received connection information request 762 is determined to be sent from the device with which the display control device 20 has previously performed the communication 50, the display control device 20 sends a connection information response 763 (and 764) to the information terminal 10 via the relay device 30. It should be noted that in this processing, the display control device 20 does not necessarily preserve information on the information terminal 10 included in the connection information request 76, but may preserve the information on the information terminal 10. Likewise, in this processing, the information terminal 10 does not necessarily preserve information on the display control device 20 included in the connection information request 764, but may preserve the information on the display control device 20.

Thus, the display control device according to the present embodiment can establish the communication 50 without performing the processing of determining whether or not to establish the communication 50, for a connection request from the information terminal with which the display control device has previously communicated.

### Embodiment 4

The present embodiment describes an information terminal and a display control device which have two or more functions among the functions described in Embodiments 1 to 3 and switches between these functions.

An information terminal according to each of Embodiments 1 to 3 described above can be achieved not only as the information terminal of each embodiment, but as the information terminal which has two or more functions among the functions described in Embodiments 1 to 3 and switches between these functions, depending on the situation. A display control device according to each of Embodiment 1 to 3 described above can be achieved not only as the display control device of each embodiment, but as the display control device which has two or more functions among the functions described in Embodiments 1 to 3 and switches between these functions, depending on the situation.

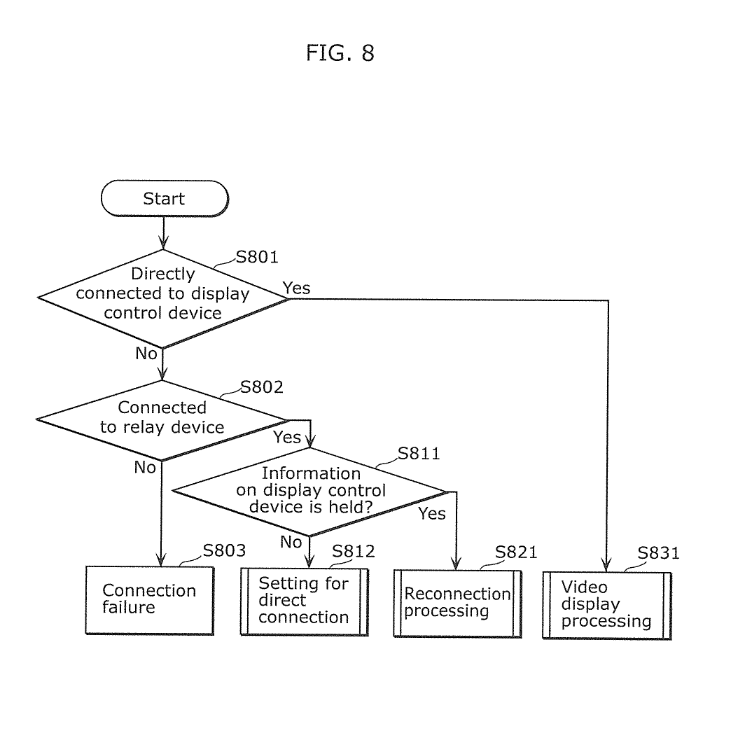

FIG. 8 is a figure for explaining switching between the functions of the information terminal according to the present embodiment.

If the information terminal 10 has established the direct communication 50 with the display control device 20 (Yes in Step S801), video display processing can be performed in the state (Step S831).

If the direct communication 50 with the display control device 20 has not been established by the information terminal 10 (No in Step S801), the information terminal 10 determines whether or not the communication 40 with the relay device 30 has been established (Step S802). If the information terminal 10 has not established the communication 40 (No in step S802), no communication can be performed (connection failure, Step S803).

Meanwhile, if the information terminal 10 has established the communication 40 (Yes in Step S802), the information terminal 10 determines whether or not the information terminal 10 has information on the display control device 20 (Step S811). If the information terminal 10 has the information on the display control device 20 (Yes in Step S811), reconnection processing is performed (Step S821). Meanwhile, if the information terminal 10 does not have the information on the display control device 20 (No in Step S811), the processing of establishing the communication 50 is performed (Step S812).

Thus, the information terminal can switch between the connection processing and video display processing, depending on the situation.

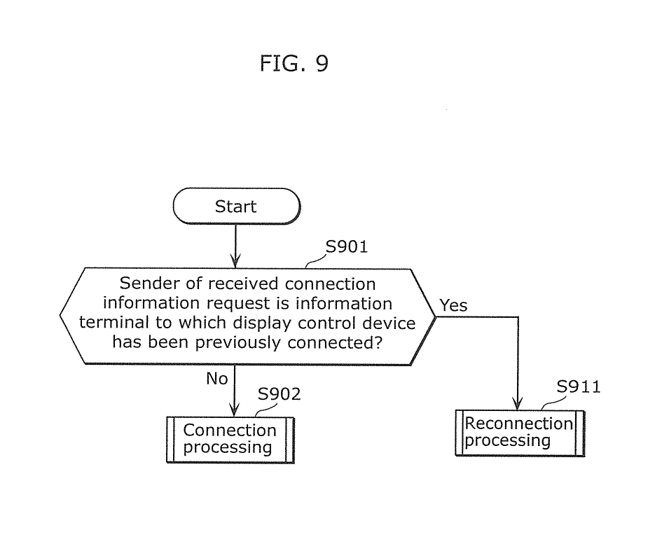

FIG. 9 is a figure for explaining switching between the functions of the display control device according to the present embodiment.

The display control device 20 determines whether or not the sender which sent a received connection information request (the connection information request 461 or the connection information request 761) is the information terminal to which the display control device 20 has been previously connected (Step S901). If this sender is the information terminal to which the display control device has been previously connected (Yes in Step S901), the reconnection processing is performed (Step S911). Meanwhile, if the sender is not the information terminal to which the display control device 20 has been previously connected (No in Step S901), the connection processing is performed (Step S902).

Thus, the display can switch between the connection processing and the reconnection processing, depending on the situation.

It should be noted that part or all of the above embodiment(s) can be also described as below. However, the present invention is not limited to the description below.

### [Additional Note 1]

An information terminal for communicating with a communication device, the information terminal comprising:

a communication unit,

a communication control unit configured to perform first communication in a local area network including the information terminal and the communication device, the first communication being communication between the information terminal and the communication device via a relay device;

a connection information obtainment unit configured to obtain, through the first communication, connection information necessary for establishment of second communication that is direct communication between the communication device and the information terminal,

wherein when the connection information obtainment unit obtains the connection information, the communication control unit is configured to cause the communication unit to break off the first communication and start the second communication using the obtained connection information.

### [Additional Note 2]

The information terminal according to Additional note 1, further comprising

a memory unit capable of storing the connection information,

wherein the connection information obtainment unit is configured to

(i) send, to the communication device, first identification information identifying the information terminal in the local area network,

(ii) receive, from the communication device as the connection information, second identification information identifying the communication device in the local area network, and

(iii) store the received second identification information in the memory unit,

when a request for the establishment of the second communication is received from the communication device, the communication control unit is configured to determine whether or not to permit the establishment, based on the second identification information stored in the memory unit, and

if the establishment is determined to be permitted, the communication control unit is configured to cause the communication unit to start the second communication.

### [Additional Note 3]

The information terminal according to Additional note 2, wherein when the request for the establishment of the second communication is received from the communication device and a sender of the request for the establishment matches a device identified by the first identification information stored in the memory unit, the communication control unit is configured to determine to permit the establishment.

### [Additional Note 4]

The information terminal according to one of Additional notes 1 to 3, further comprising:

an initial setting unit configured to make an initial setting of the information terminal by performing a setting to enable the communication device to connect to the local area network, and causing the connection information obtainment unit to obtain the connection information.

### [Additional Note 5]

The information terminal according to one of Additional notes 1 to 4, further comprising

a processing unit configured to create image data and send the created image data,

wherein the second communication includes communication for sending the image data created by the processing unit to the communication device, and

the communication device creates an image from the image data received through the second communication, and controls display of the created image.

### [Additional Note 6]

A communication system comprising:

a communication device described in one of the above embodiments; and

the information terminal according to one of Additional notes 1 to 5.

According to Additional note 1, the information terminal can obtain the information necessary for the direct communication (the second communication) without the relay device, through the communication (the first communication) with the communication device via the relay device, and establish the second communication to perform the processing using the second communication. That is, the information terminal can establish the second communication with the communication device in the local area network even if the user does not operate to input the necessary information for the second communication to the communication device. Thus, the information terminal can be connected to the communication device in an easier way for users.

Moreover, according to Additional note 2, the information terminal determines whether to permit or deny the establishment, based on the information necessary for the second communication received from the communication device through the first communication and the information included in the subsequent request for the establishment of the second communication from the communication device. Thus, the information terminal can establish the second communication with the communication device with which the information terminal performed the first communication.

Moreover, according to Additional note 3, when the information necessary for the second communication received from the communication device through the first communication matches the information included in the subsequent request for the establishment of the second communication from the communication device, the information terminal establishes the second communication. This can ensure that the informational terminal establishes the second communication with the communication device with which the information terminal performed the first communication.

Moreover, according to Additional note 4, the information terminal can obtain the information necessary for the second communication as one of the initial settings of the information terminal. For instance, the user performs the initial settings of the information terminal after purchasing the information terminal, to connect the informational terminal to the local area network in the home of the user.

Moreover, according to Additional note 5, the information terminal can cause the display device to display the image data created by the information terminal.

Moreover, Additional note 6 gives similar advantages achieved by the above information terminal or communication device.

The information terminals and display control devices according to the embodiments of the present invention were described above. However, the present invention is not limited to these embodiments.

Moreover, each device described above may be a computer system including, for example, a microprocessor, a ROM, a RAM, a hard disk drive, a display unit, a keyboard, and a mouse. A computer program is stored in the RAM or hard disk drive. Each device achieves its function by the microprocessor operating in accordance with the computer program. Here, the computer program is the combination of instruction codes for instructing the computer to achieve a predetermined function.

Furthermore, a part or all of the structural elements of each device described above may be one system large scale integration (LSI). The system LSI is a super multifunctional LSI manufactured by integrating more than one component on one chip and, in particular, a computer system including, for example, a microprocessor, a ROM, and a RAM. A computer program is stored in the RAM. The system LSI achieves its function by the microprocessor operating in accordance with the computer program.

Furthermore, a part or all of the structural elements of each device described above may be an IC card or single module detachable to each device. The IC card or module is a computer system including a microprocessor, a ROM, and a RAM. The IC card or module may include the above super multifunctional LSI. The IC card or module achieves its function by the microprocessor operating in accordance with the computer program. This IC card or module may be tamper resistant.

Moreover, the present invention may be the method(s) described above. Moreover, the present invention may be a computer program with which a computer achieves these methods or a digital signal including the above computer program.

Furthermore, in the present invention, the computer program or digital signal may be recorded on a computer-readable non-transitory recording medium such as a flexible disk, a hard disk, a CD-ROM, a MO, a DVD, a DVD-ROM, a DVD-RAM, a blu-ray (registered trademark) disc (BD), or a semiconductor memory. Moreover, the present invention may be the digital signal recorded on one of these non-transitory recording media.

Moreover, the present invention may transmit the computer program or digital signal through, for example, a telecommunication line, a wireless or wired communication line, a network represented by the Internet, and data broadcasting.

Moreover, the present invention may be a computer system including a microprocessor and a memory. The memory may store the computer program. The microprocessor may operate in accordance with the computer program.

Moreover, the present invention may be achieved by independent other computer system by recording the program or digital signal on the non-transitory recording medium and transferring it, or transferring the program or digital signal via the network or others.

Furthermore, optional combinations of the embodiments and modifications are also possible.

### INDUSTRIAL APPLICABILITY

A communication device according to the present invention is applicable to a communication device which can be connected to other device more easily for users. Specifically, the communication device according to the present invention is applicable to a cellular phone, a smartphone, a television, a set top box (STB), and a communication system including these.

1. A communication device for communicating with an information terminal, the communication device comprising:
a communication unit;
a communication control unit configured to cause the communication unit to perform first communication in a local area network including the communication device and the information terminal, the first communication being communication between the communication device and the information terminal via a relay device; and
a connection information obtainment unit configured to obtain, from the information terminal through the first communication, connection information necessary for establishment of second communication that is direct communication between the communication device and the information terminal,
wherein when the connection information obtainment unit obtains the connection information, the communication control unit is configured to cause the communication unit to break off the first communication and start the second communication using the obtained connection information.

2. The communication device according to claim 1, further comprising
a memory unit capable of storing the connection information,
wherein the connection information obtainment unit is configured to
(i) receive, from the information terminal as the connection information, first identification information identifying the information terminal in the local area network,
(ii) store the received first identification information in the memory unit, and
(iii) send, to the communication device, second identification information identifying the communication device in the local area network,
when a request for the establishment of the second communication is received from the information terminal, the communication control unit is configured to determine whether or not to permit the establishment, based on the first identification information stored in the memory unit, and
if the establishment is determined to be permitted, the communication control unit is configured to cause the communication unit to start the second communication.

3. The communication device according to claim 2,
wherein when the request for the establishment of the second communication is received from the information terminal and a sender of the request for the establishment matches a device identified by the first identification information stored in the memory unit, the communication control unit is configured to determine to permit the establishment.

4. The communication device according to claim 1, further comprising
an initial setting unit configured to make an initial setting of the communication device by performing a setting to enable the communication device to connect to the local area network, and causing the connection information obtainment unit to obtain the connection information.

5. The communication device according to claim 2,
wherein when the first identification information is received, the connection information obtainment unit is configured to present, to a user, information for a query about whether or not to establish the second communication with a device identified by the received first identification information, and control the establishment of the second communication, depending on a response from the user to the query.

6. The communication device according to claim 5,
wherein if a response is not obtained from the user after elapse of a predetermined time since presenting an image for the query to the user, the connection information obtainment unit is configured to control the establishment of the second communication by determining whether or not to establish the second communication.

7. The communication device according to claim 5,
wherein when the connection information obtainment unit has received the first identification information and the device identified by the received first identification information has previously communicated with the communication device, the connection information obtainment unit is configured to establish the second communication with the device identified by the received first identification information.

8. The communication device according to claim 1,
wherein the information terminal creates image data, and
the second communication includes communication for sending the image data created by the information terminal to the communication device,
the communication device further comprising:
a processing unit configured to receive the image data through the second communication, to create an image from the received image data; and
a display control unit configured to control display of the image created by the processing unit on a display screen.
